(19) United States
(12) Patent Application Publication
(10) Pub. No.: US 2017/0356881 A1
(43) Pub. Date: Dec. 14, 2017

(54) METHOD AND DEVICE FOR PROCESSING MAGNETOSTRICTIVE GUIDED WAVE DETECTION SIGNALS

(71) Applicant: Huazhong University of Science and Technology, Wuhan (CN)

(72) Inventors: Xinjun WU, Wuhan (CN); Mingxi TANG, Wuhan (CN); Pengfei SUN, Wuhan (CN)

(21) Appl. No.: 15/687,536

(22) Filed: Aug. 27, 2017

Related U.S. Application Data
(63) Continuation-in-part of application No. 14/538,787, filed on Nov. 11, 2014.
Application No. 14/538,787 is a continuation-in-part of application No. PCT/CN2014/079703, filed on Jun. 12, 2014.

(30) Foreign Application Priority Data
Dec. 24, 2013 (CN) 201310723746.0

(51) Int. Cl. G01N 27/82; G01N 29/52; G01N 29/24

(52) U.S. Cl. CPC G01N 27/82; G01N 29/2412; G01N 29/52

(57) ABSTRACT

A method for denoising magnetostrictive guided wave detection signals to improve detection accuracy. The method includes forming a matrix A by using the signals; performing a singular value decomposition on the matrix A to obtain a singular matrix B including a plurality of eigenvalues; setting eigenvalues in the singular matrix B that are smaller than the median to zero to obtain a matrix C; performing an inverse transformation of the singular value decomposition on the matrix C to obtain a matrix D; and determining the denoised signals according to the matrix D.

### CROSS-REFERENCE TO RELATED APPLICATIONS

This application is a continuation-in-part of U.S. patent application Ser. No. 14/538,787, filed Nov. 11, 2014, now pending, which is a continuation-in-part of International Patent Application No. PCT/CN2014/079703 with an international filing date of Jun. 12, 2014, designating the United States, now pending, and further claims priority benefits to Chinese Patent Application No. 201310723746.0 filed Dec. 24, 2013. The contents of all of the aforementioned applications, including any intervening amendments thereto, are incorporated herein by reference.

### BACKGROUND OF THE INVENTION

### Field of the Invention

The invention relates to a technical field of non-destructive testing, and more particularly to a method and a device for processing magnetostrictive guided wave detection signals.

### Description of the Related Art

Magnetostrictive guided waves technology has been applied in industry in recent years. However, low conversion efficiency and low signal to noise ratio restrict the applications thereof. In addition, the technology requires collecting signals with respect to the defect-free samples as standards, which is similarly limiting.

### SUMMARY OF THE INVENTION

In view of the above-mentioned problems, it is an objective of the invention to provide a method and a device for processing magnetostrictive guided wave detection signals. The method obtains an energy distribution of a denoised magnetostrictive guided wave detection signal by suppressing the background noise under certain threshold to reduce the impact of external interference on the signal. The method does not require collecting signals with respect to the defect-free samples and has various applications.

To achieve the above objective, in accordance with one embodiment of the invention, there is provided a method for denoising a magnetostrictive guided wave detection voltage that is induced by the magnetostrictive guided wave, that is, in turn, induced by an alternating current pulse, the method operating to improve accuracy in detecting the magnetostrictive guided waves, and comprising:
1) by means of a computer, capturing analysis signals u(0), u(1), u(2), . . . , u(N) from the magnetostrictive guided wave detection voltage;
2) by means of a band-pass filter, filtering the analysis signals u(0), u(1), u(2), . . . , u(N) to obtain filtered signals x(0), x(1), x(2), . . . , x(N); and
3) by means of the computer, denoising the filtered signals x(0), x(1), x(2), . . . , x(N) to obtain the denoised signals y(0), y(1), y(2), . . . , y(N) by:
   a) initializing i to “0” and setting M=[L/4], R=[M/2], wherein L is the length of the alternating current pulse;
   b) forming a matrix A of R*(M−R+1) by using the filtered signals x(i), x(i+1), . . . , x(i+M−1):

$$A = [ \begin{matrix}x ( i ) & x ( i + 1 ) & … & x ( i + M - R ) \\ x ( i + 1 ) & x ( i + 2 ) & … & x ( i + M - R + 1 ) \\ ⋮ & ⋮ & ⋱ & ⋮ \\ x ( i + R - 1 ) & x ( i + R ) & … & x ( i + M - 1 )\end{matrix} ] ;$$

c) performing a singular value decomposition on the matrix A to obtain a singular matrix B comprising a plurality of eigenvalues λ₁, λ₂, . . . , λ_{R}:

$$B = [ \begin{matrix}{λ}_{1} & 0 & … & 0 & … & 0 \\ 0 & {λ}_{2} & … & 0 & … & 0 \\ ⋮ & ⋮ & ⋱ & ⋮ & ⋮ & ⋮ \\ 0 & 0 & … & {λ}_{R} & … & 0\end{matrix} ] ;$$

d) determining a median of the plurality of eigenvalues and selecting eigenvalues that are smaller than the median from the plurality of eigenvalues;
e) setting the selected eigenvalues in d) in the singular matrix B to “0” to obtain a matrix C;
f) performing an inverse transformation of the singular value decomposition on the matrix C to obtain a matrix D:

$$D = [ \begin{matrix}y ( i ) & y ( i + 1 ) & … & y ( i + M - R ) \\ y ( i + 1 ) & y ( i + 2 ) & … & y ( i + M - R + 1 ) \\ ⋮ & ⋮ & ⋱ & ⋮ \\ y ( i + R - 1 ) & y ( i + R ) & … & y ( i + M - 1 )\end{matrix} ] ;$$

g) determining the denoised signals y(i), y(i+1), . . . , y(i+M−1) according to the matrix D; and
h) setting i to (i+M) and returns to b) until i=N+1−M to obtain the denoised signals y(0), y(1), y(2), . . . , y(N).

In accordance with another embodiment of the invention, there is provided a method for detecting defects in a heat exchange pipe made of ferromagnetic materials, the method comprising:
1) disposing an excitation coil and a receiving coil on the heat exchange pipe, and inputting an alternating current pulse in the excitation coil to excite a magnetostrictive guided wave in the heat exchange pipe, wherein the magnetostrictive guided wave induces a magnetostrictive guided wave detection voltage in the receiving coil;
2) by means of a computer, capturing analysis signals u(0), u(1), u(2), . . . , u(N) from the magnetostrictive guided wave detection voltage;
3) by means of a band-pass filter, filtering the analysis signals u(0), u(1), u(2), . . . , u(N) to obtain filtered signals x(0), x(1), x(2), . . . , x(N);
4) by means of the computer, denoising the filtered signals x(0), x(1), x(2), . . . , x(N) to obtain denoised signals y(0), y(1), y(2), . . . , y(N) by:
   a) initializing i to “0” and setting M=[L/4], R=[M/2], wherein L is the length of the alternating current pulse;
   b) forming a matrix A of R*(M−R+1) by using the filtered signals x(i), x(i+1), . . . , x(i+M−1):

$$A = [ \begin{matrix}x ( i ) & x ( i + 1 ) & … & x ( i + M - R ) \\ x ( i + 1 ) & x ( i + 2 ) & … & x ( i + M - R + 1 ) \\ ⋮ & ⋮ & ⋱ & ⋮ \\ x ( i + R - 1 ) & x ( i + R ) & … & x ( i + M - 1 )\end{matrix} ] ;$$

c) performing a singular value decomposition on the matrix A to obtain a singular matrix B comprising a plurality of eigenvalues λ₁, λ₂, . . . , λ_{R}:

$$B = [ \begin{matrix}{λ}_{1} & 0 & … & 0 & … & 0 \\ 0 & {λ}_{2} & … & 0 & … & 0 \\ ⋮ & ⋮ & ⋱ & ⋮ & ⋮ & ⋮ \\ 0 & 0 & … & {λ}_{R} & … & 0\end{matrix} ]$$

d) determining a median of the plurality of eigenvalues and selecting eigenvalues that are smaller than the median from the plurality of eigenvalues;
e) setting the selected eigenvalues in step d) in the singular matrix B to zero to obtain a matrix C;
f) performing an inverse transformation of the singular value decomposition on the matrix C to obtain a matrix D:

$$D = [ \begin{matrix}y ( i ) & y ( i + 1 ) & … & y ( i + M - R ) \\ y ( i + 1 ) & y ( i + 2 ) & … & y ( i + M - R + 1 ) \\ ⋮ & ⋮ & ⋱ & ⋮ \\ y ( i + R - 1 ) & y ( i + R ) & … & y ( i + M - 1 )\end{matrix} ] ;$$

g) determining the denoised signals y(i), y(i+1), . . . , y(i+M−1) according to the matrix D; and
h) setting i to (i+M) and returns to b) until i=N+1−M to obtain the denoised signals y(0), y(1), y(2), . . . , y(N).
5) by means of the computer, calculating energies z(0), z(1), z(2), . . . , z(N) of the denoised signals y(0), y(1), y(2), . . . , y(N), wherein the energies are calculated according to the equation z(n)=y²(0)+ . . . +y²(n), n is an integral variable, and 0≦n≦N;
6) by means of the computer, drawing an energy distribution diagram according to the energies z(0), z(1), z(2), . . . , z(N); and
by means of the computer, determining positions of the defects in the heat exchange pipe according to the energy distribution diagram.

In accordance with another embodiment of the invention, there is provided a device for processing magnetostrictive guided wave detection signals, operable for improving accuracy of magnetostrictive guided wave detection, the magnetostrictive guided wave detection signals being induced by the magnetostrictive guided wave induced by an excitation signal; the device comprising a band-pass filter and a CPU having a software program; the software program comprising a signal capturing acquiring module and a signal processing module;
the signal capturing acquiring module is operable for capturing an original magnetostrictive guided wave detection signal to obtain an analysis signal u(n), where n≦N, and N is the length of the analysis signal u(n);
the band-pass filter is connected to the signal capturing module and operable for performing band-pass filtering on the analysis signal u(n) to obtain a signal x(n); and
the signal processing module is connected to the band-pass filter and operable for denoising the signal x(n) and calculating the energy distribution of the denoised signal;
the signal processing module operates as follows:
   obtaining a group of signals x(i), x(i+1), . . . , x(i+M−1) using a rectangular window with a width of M, where M=[L/4], and L is the length of the excitation signal; and initializing i to “0”;
   forming a matrix A of R*(M−R+1), where R=[M/2]:

$$A = [ \begin{matrix}x ( i ) & x ( i + 1 ) & … & x ( i + M - R ) \\ x ( i + 1 ) & x ( i + 2 ) & … & x ( i + M - R + 1 ) \\ ⋮ & ⋮ & ⋱ & ⋮ \\ x ( i + R - 1 ) & x ( i + R ) & … & x ( i + M - 1 )\end{matrix} ] ;$$

performing singular value decomposition on the matrix A to obtain a singular matrix B:

$$B = [ \begin{matrix}{λ}_{1} & 0 & … & 0 & … & 0 \\ 0 & {λ}_{2} & … & 0 & … & 0 \\ ⋮ & ⋮ & ⋱ & ⋮ & ⋮ & ⋮ \\ 0 & 0 & … & {λ}_{R} & … & 0\end{matrix} ] ,$$

λⱼ represents an eigenvalue, and j=1, 2, . . . R;
setting eigenvalues in the matrix B smaller than the median to “0” to obtain a matrix C, and performing inverse singular value transformation on the matrix C to obtain a matrix D:

$$D = [ \begin{matrix}y ( i ) & y ( i + 1 ) & … & y ( i + M - R ) \\ y ( i + 1 ) & y ( i + 2 ) & … & y ( i + M - R + 1 ) \\ ⋮ & ⋮ & ⋱ & ⋮ \\ y ( i + R - 1 ) & y ( i + R ) & … & y ( i + M - 1 )\end{matrix} ] ;$$

recovering a group of processed signals y(i), y(i+1), . . . , y(i+M−1) from the matrix D;
setting i to (i+M) and repeating the steps in paragraphs [0046]-[0053] of obtaining a group of signals x(i), x(i+1), . . . , x(i+M−1) using a rectangular window with a width of M and processing the signals until i=N+1−M, whereby obtaining the denoised signals y(0), y(1), y(2), . . . , y(N),
calculating energies z(0), z(1), z(2), . . . , z(N) of the denoised signals y(0), y(1), y(2), . . . , y(N), wherein the energies are calculated according to the equation z(n)=y²(0)+ . . . +y²(n), n is an integral variable, and 0≦n≦N.
In a class of the embodiment, the software program further comprises a defect detecting module, connected to the signal processing module, and operable for drawing an energy distribution diagram according to the energy of denoised signals and determining whether a defect exists in a test sample according to a distortion characteristic of the energy distribution diagram.

The principle of the invention is that a magnetostrictive guided wave propagating in a sample at a group velocity is reflected, diffracted or transmitted in a different way due to existence of defects and other irregular structures which causes changes in the signal waveform and the propagating energy in corresponding positions. In the prior art, a defect-free sample is required for collecting a standard signal, and differential and other processes should be carried out on a test signal and the standard signal, which is unfavorable for field detection. However, the invention obtains an energy distribution of a magnetostrictive guided wave detection signal by suppressing the background noise under certain threshold to reduce the impact of external interference on the signal, so that the accuracy of magnetostrictive guided wave signal detection is improved by improving the signal to noise ratio. The method requires no standard samples and greatly facilitates field application.

### BRIEF DESCRIPTION OF THE DRAWINGS

FIG. 1 is a flow chart of a method for processing magnetostrictive guided wave detection signals according to one embodiment of the invention;

FIG. 2 is a schematic diagram of a device for processing magnetostrictive guided wave detection signals according to one embodiment of the invention;

FIG. 3 is an experimental layout for detecting a defective standard pipe according to one embodiment of the invention;

FIG. 4 is a schematic diagram of an original signal detected from a defective pipe with an outside diameter of 25 mm and an inside diameter of 20 mm according to one embodiment of the invention;

FIG. 5 is a schematic diagram of an analysis signal obtained by capturing an original signal detected from a defective pipe;

FIG. 6 is an energy distribution diagram of signals obtained by processing an analysis signal of a defective pipe by the method of the invention;

FIG. 7 is an experimental layout for detecting a defect-free standard pipe according to one embodiment of the invention;

FIG. 8 is a schematic diagram of an original signal detected from a defect-free pipe with an outside diameter of 25 mm and an inside diameter of 20 mm;

FIG. 9 is a schematic diagram of an analysis signal obtained by capturing an original signal detected from a defect-free pipe; and

FIG. 10 is an energy distribution diagram of signals obtained by processing an analysis signal of a defect-free pipe by the method of the invention.

### DETAILED DESCRIPTION OF THE EMBODIMENTS

For clear understanding of the objectives, features and advantages of the invention, detailed description of the invention will be given below in conjunction with accompanying drawings and specific embodiments. It should be noted that the examples are only meant to explain the invention, and not to limit the scope of the invention.

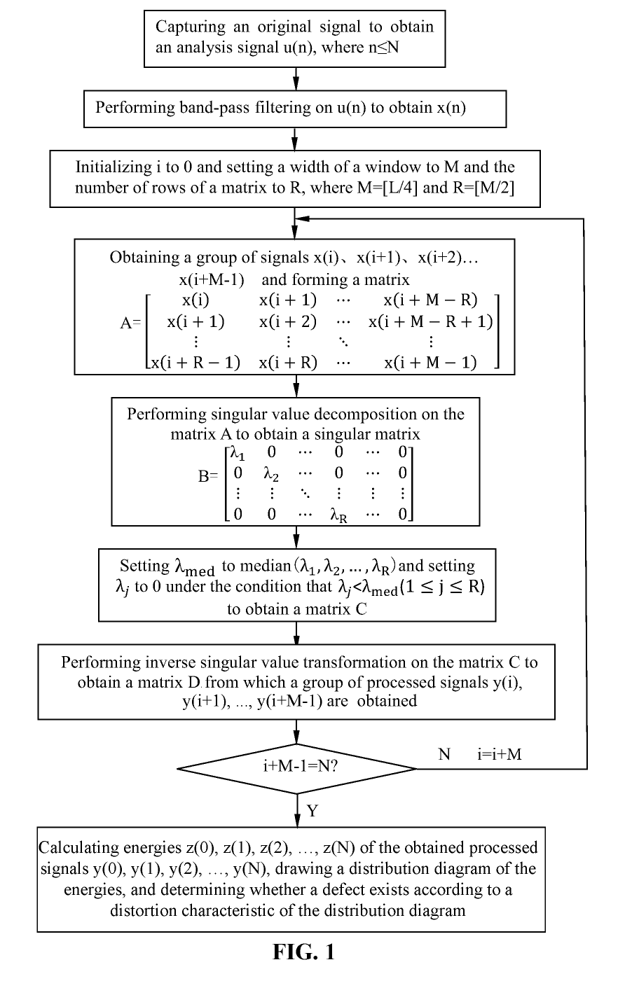

FIG. 1 is a flow chart of a method for improving accuracy of magnetostrictive guided wave detection according to the invention. As shown in FIG. 1, the method for improving accuracy of magnetostrictive guided wave detection comprises steps of:

S1: obtaining an analysis signal u(n) from capturing an original magnetostrictive guided wave detection signal that is induced by the magnetostrictive guided wave induced by an excitation signal, where n≦N, and N is the length of the analysis signal u(n);

S2: performing band-pass filtering on the analysis signal u(n) to obtain a signal x(n), and initializing i to “0”;

S3: obtaining a group of signals x(i), x(i+1), . . . , x(i+M−1) using a rectangular window with a width of M, where M=[L/4], and L is the length of the excitation signal which is an alternating current pulse;

S4: forming a matrix A of R*(M−R+1), where R=[M/2]:

$$A = [ \begin{matrix}x ( i ) & x ( i + 1 ) & … & x ( i + M - R ) \\ x ( i + 1 ) & x ( i + 2 ) & … & x ( i + M - R + 1 ) \\ ⋮ & ⋮ & ⋱ & ⋮ \\ x ( i + R - 1 ) & x ( i + R ) & … & x ( i + M - 1 )\end{matrix} ] ;$$

S5: performing singular value decomposition on the matrix A to obtain a singular matrix B:

$$B = [ \begin{matrix}{λ}_{1} & 0 & … & 0 & … & 0 \\ 0 & {λ}_{2} & … & 0 & … & 0 \\ ⋮ & ⋮ & ⋱ & ⋮ & ⋮ & ⋮ \\ 0 & 0 & … & {λ}_{R} & … & 0\end{matrix} ] ,$$

λⱼ represents an eigenvalue, and j=1, 2, . . . R;

S6: setting λ_{med} to median(λ₁, λ₂, . . . , λ_{R}) and setting λⱼ to zero under the condition that λⱼ<λ_{med} (1≦j≦R) to obtain a matrix C, namely setting eigenvalues in the matrix B smaller than the median to “0” to obtain the matrix C; and performing inverse singular value transformation on the matrix C to obtain a matrix D:

$$D = [ \begin{matrix}y ( i ) & y ( i + 1 ) & … & y ( i + M - R ) \\ y ( i + 1 ) & y ( i + 2 ) & … & y ( i + M - R + 1 ) \\ ⋮ & ⋮ & ⋱ & ⋮ \\ y ( i + R - 1 ) & y ( i + R ) & … & y ( i + M - 1 )\end{matrix} ] ;$$

S7: recovering a group of processed signals y(i), y(i+1), . . . , y(i+M−1) from the matrix D;

S8: setting i to (i+M) and repeating steps S3-S7 until i=N+1−M, whereby obtaining all processed signals y(0), y(1), y(2), . . . , y(N);

S9: calculating energies z(0), z(1), z(2), . . . , z(N) of the processed signals y(0), y(1), y(2), . . . , y(N) obtained in S8, wherein z(n) is the sum of the squares of the denoised signals y(0), . . . , and y(n), i.e., z(n)=y²(0)+ . . . +y²(n), n is an integral variable and 0≦n≦N; and

S10: drawing an energy distribution diagram according to the energies of processed signals and determining whether a defect exists in a sample according to a distortion characteristic of the energy distribution diagram.

FIG. 2 is a schematic diagram of a device for processing magnetostrictive guided wave detection signals according to the invention. As shown in FIG. 2, the device for processing magnetostrictive guided wave detection signals comprises a signal capturing unit 1, a band-pass filter 2 connected to the signal capturing unit 1, a signal processing unit 3 connected to the band-pass filter 2, and a defect detecting unit 4 connected to the signal processing unit 3. The signal capturing unit 1, the signal processing unit 3, the defect detecting unit 4 are modules of a software program in a CPU. The signal capturing unit 1 is operable for capturing an original magnetostrictive guided wave detection signal to obtain an analysis signal u(n), where n≦N, and N is the length of the analysis signal u(n). The band-pass filter 2 is operable for performing band-pass filtering on the analysis signal u(n) to obtain a signal x(n). The signal processing unit 3 is operable for denoising the signal x(n) and calculating the energy distribution of the denoised signal, where the signal processing unit 3 operates as follows:

obtaining a group of signals x(i), x(i+1), x(i+M−1) using a rectangular window with a width of M, where M=[L/4], and L is the length of the excitation signal; and initializing i to “0”;

forming a matrix A of R*(M−R+1), where R=[M/2]:

$$A = [ \begin{matrix}x ( i ) & x ( i + 1 ) & … & x ( i + M - R ) \\ x ( i + 1 ) & x ( i + 2 ) & … & x ( i + M - R + 1 ) \\ ⋮ & ⋮ & ⋱ & ⋮ \\ x ( i + R - 1 ) & x ( i + R ) & … & x ( i + M - 1 )\end{matrix} ] ;$$

performing singular value decomposition on the matrix A to obtain a singular matrix B:

$$B = [ \begin{matrix}{λ}_{1} & 0 & … & 0 & … & 0 \\ 0 & {λ}_{2} & … & 0 & … & 0 \\ ⋮ & ⋮ & ⋱ & ⋮ & ⋮ & ⋮ \\ 0 & 0 & … & {λ}_{R} & … & 0\end{matrix} ] ,$$

λⱼ represents an eigenvalue, and j=1, 2, . . . R;

setting eigenvalues in the matrix B smaller than the median to “0” to obtain a matrix C, and performing inverse singular value transformation on the matrix C to obtain a matrix D:

$$D = [ \begin{matrix}y ( i ) & y ( i + 1 ) & … & y ( i + M - R ) \\ y ( i + 1 ) & y ( i + 2 ) & … & y ( i + M - R + 1 ) \\ ⋮ & ⋮ & ⋱ & ⋮ \\ y ( i + R - 1 ) & y ( i + R ) & … & y ( i + M - 1 )\end{matrix} ] ;$$

recovering a group of processed signals y(i), y(i+1), . . . , y(i+M−1) from the matrix D; and
setting i to (i+M) and repeating the steps in paragraphs [0084]-[0091] of obtaining a group of signals x(i), x(i+1), . . . , x(i+M−1) using a rectangular window with a width of M and processing the signals until i=N+1−M, whereby obtaining the processed signals y(0), y(1), y(2), . . . , y(N).
calculating energies z(0), z(1), z(2), . . . , z(N) of the processed signals y(0), y(1), y(2), . . . , y(N), wherein the energies are calculated according to the equation z(n)=y²(0)+ . . . +y²(n), n is an integral variable, and 0≦n≦N.

The defect detecting unit 4 is operable for drawing an energy distribution diagram according to the energy of processed signals and determining whether a defect exists in a test sample according to a distortion characteristic of the energy distribution diagram.

A specific embodiment is provided below according to the invention.

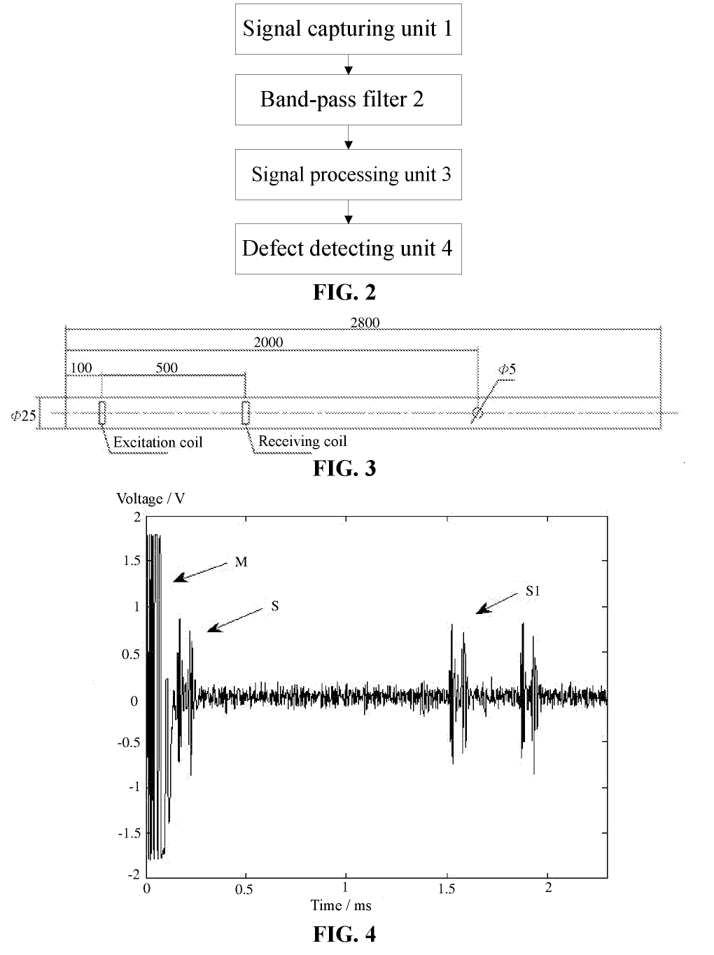

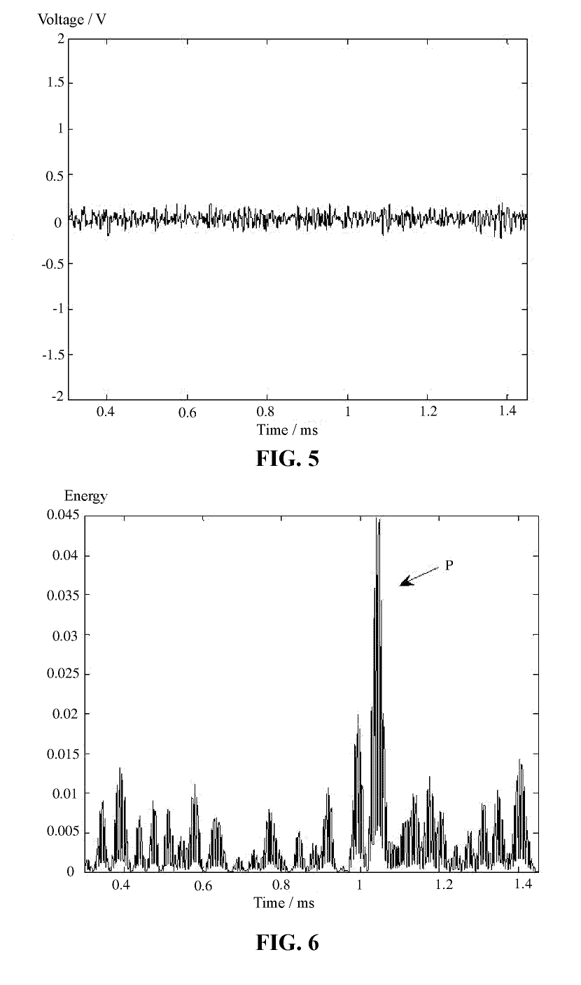

As shown in FIG. 3, a defective heat exchange pipe with an outside diameter of 25 mm, an inside diameter of 20 mm, and a length of 2800 mm is used as a test sample. The heat exchange pipe is made of ferromagnetic materials. An excitation coil is disposed around the pipe at the position having a distance 100 mm from the left end of the pipe, a receiving coil is disposed around the pipe at the position having a distance 600 mm from the left end of the pipe, and a hole (i.e., a defect) with a diameter of 5 mm exists in the pipe at the position having a distance 2000 mm from the left end of the pipe. An alternating current pulse, of which the frequency is 90 kHz, is input into the excitation coil to generate an alternating magnetic field. Due to magnetostrictive effect, the alternating magnetic field induces an alternating stress in the pipe. Then the alternating stress in the pipe generates a magnetostrictive guided wave propagating in the pipe at the speed of about 3200 m/s. When the magnetostrictive guided wave passes through the receiving coil, the magnetostrictive guided wave changes the magnetic flux through the receiving coil due to inverse magnetostrictive effect, resulting in a magnetostrictive guided wave detection voltage in the receiving coil. The magnetostrictive guided wave detection voltage (which is an analog signal) is sampled to obtain an original signal (which is a digital signal), and the sampling frequency is 2000 kHz. A computer is connected to the receiving coil to process the original signal. A schematic diagram of the original signal is shown in FIG. 4, which includes an electromagnetic pulse signal M, a signal S passed through the receiving coil for the first time, and a signal S1 reflected by the right end of the pipe for the first time. In order to facilitate analysis, the original signal in FIG. 4 is cut to obtain an analysis signal of the defective pipe between S and S1 (S and S1 not included), which is shown in FIG. 5. A defective signal should exist when t equals 1.03 ms according to calculation, which cannot be identified according to FIG. 5. The analysis signal of the defective pipe is processed by the method of the present invention by selecting a rectangular window with a width of 6 and forming a matrix of 3*4. FIG. 6 is an energy distribution diagram of signals obtained by processing the analysis signal of the defective pipe by the method of the invention. As shown in FIG. 6, a significant distortion P occurs in the energy at 1.03 ms and the peak value of P greatly increases. The occurring time matches with the theoretical time, so that it can be concluded that the distortion is caused by the defection.

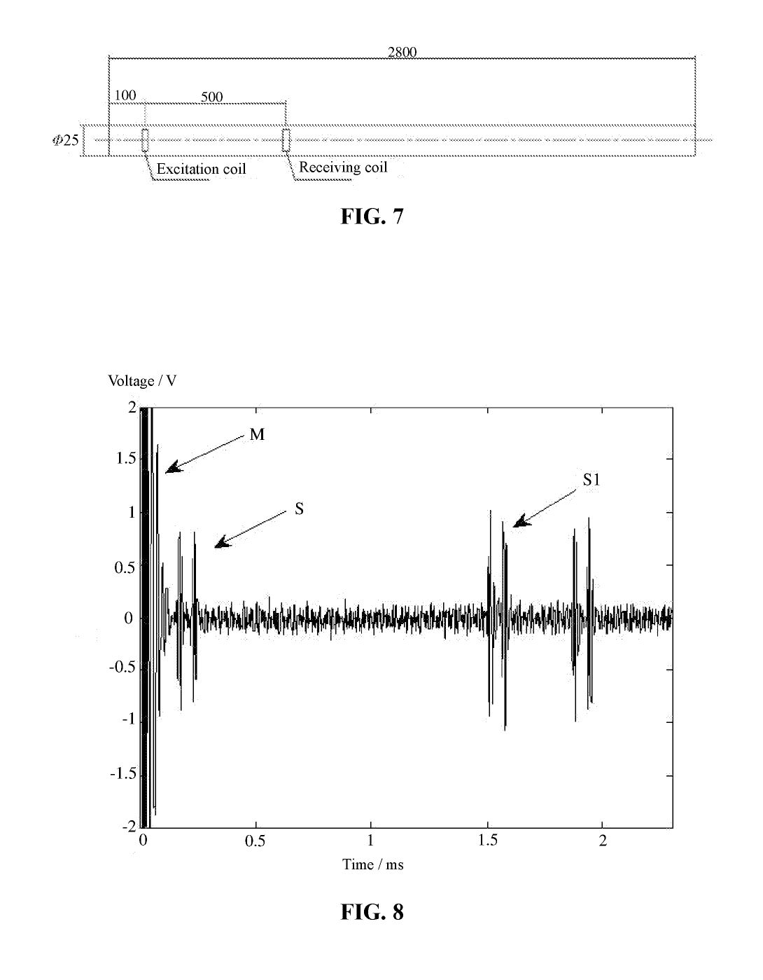

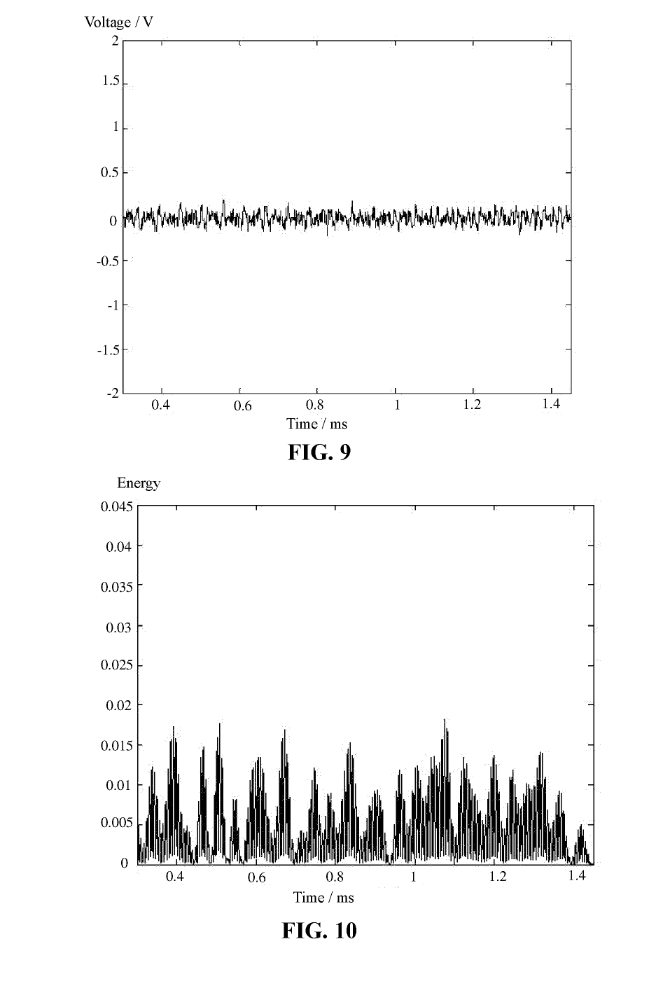

A defect-free heat exchange pipe having the same specifications with the defective heat exchange pipe is provided. The experimental layout, the excitation frequency, the sampling frequency and the guided wave speed remain unchanged. FIG. 7 is the experimental layout for detecting the defect-free pipe. FIG. 8 is a schematic diagram of an original signal detected from the defect-free pipe, which is cut to obtain an analysis signal of the defect-free pipe ranging from S to S1. FIG. 9 is a schematic diagram of the analysis signal obtained by capturing the original signal detected from the defect-free pipe. FIG. 10 is an energy distribution diagram of signals obtained by processing the analysis signal of a defect-free pipe by the method of the invention, unlike the energy distribution diagram of the defective pipe (FIG. 6), no obvious distortion occurs. Therefore, it can be concluded that the method of the invention is effective and reliable.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A method for detecting defects in a heat exchange pipe, said heat exchange pipe being made of ferromagnetic materials, the method comprising:
1) disposing an excitation coil and a receiving coil on said heat exchange pipe, and inputting an alternating current pulse in said excitation coil to excite a magnetostrictive guided wave in said heat exchange pipe to induce a magnetostrictive guided wave detection voltage in said receiving coil;
2) by means of a computer, capturing analysis signals u(0), u(1), u(2), . . . , u(N) from said magnetostrictive guided wave detection voltage;
3) by means of a band-pass filter, filtering said analysis signals u(0), u(1), u(2), . . . , u(N) to obtain filtered signals x(0), x(1), x(2), . . . , x(N);
4) by means of the computer, denoising said filtered signals x(0), x(1), x(2), . . . , x(N) to obtain denoised signals y(0), y(1), y(2), . . . , y(N) by:
a) initializing i to zero and setting M=[L/4], R=[M/2], wherein L is a length of said alternating current pulse;
b) forming a matrix A of R*(M−R+1) by using said filtered signals x(i), x(i+1), . . . , x(i+M−1):
$$A = [ \begin{matrix}x ( i ) & x ( i + 1 ) & … & x ( i + M - R ) \\ x ( i + 1 ) & x ( i + 2 ) & … & x ( i + M - R + 1 ) \\ ⋮ & ⋮ & ⋱ & ⋮ \\ x ( i + R - 1 ) & x ( i + R ) & … & x ( i + M - 1 )\end{matrix} ] ;$$
c) performing a singular value decomposition on said matrix A to obtain a singular matrix B comprising a plurality of eigenvalues λ₁, λ₂, . . . , λ_{R}:
$$B = [ \begin{matrix}{λ}_{1} & 0 & … & 0 & … & 0 \\ 0 & {λ}_{2} & … & 0 & … & 0 \\ ⋮ & ⋮ & ⋱ & ⋮ & ⋮ & ⋮ \\ 0 & 0 & … & {λ}_{R} & … & 0\end{matrix} ] ;$$
d) determining a median of said plurality of eigenvalues and selecting eigenvalues that are smaller than said median from said plurality of eigenvalues;
e) setting said selected eigenvalues in d) in said singular matrix B to zero to obtain a matrix C;
f) performing an inverse transformation of the singular value decomposition on said matrix C to obtain a matrix D:
$$D = [ \begin{matrix}y ( i ) & y ( i + 1 ) & … & y ( i + M - R ) \\ y ( i + 1 ) & y ( i + 2 ) & … & y ( i + M - R + 1 ) \\ ⋮ & ⋮ & ⋱ & ⋮ \\ y ( i + R - 1 ) & y ( i + R ) & … & y ( i + M - 1 )\end{matrix} ] ;$$
g) determining said denoised signals y(i), y(i+1), . . . , y(i+M−1) according to said matrix D; and
h) setting i to (i+M) and returns to b) until i=N+1−M to obtain said denoised signals y(0), y(1), y(2), . . . , y(N);
5) by means of the computer, calculating energies z(0), z(1), z(2), . . . , z(N) of said denoised signals y(0), y(1), y(2), . . . , y(N), wherein said energy z(n) is calculated according to the equation z(n)=y2(0)+ . . . +y2(n), n is an integral variable, and 0≦n≦N;
6) by means of the computer, drawing an energy distribution diagram according to said energies z(0), z(1), z(2), . . . , z(N); and
7) by means of the computer, determining positions of the defects in said heat exchange pipe according to said energy distribution diagram.

2. A method for denoising a detection voltage to obtain denoised signals, the detection voltage being induced by a magnetostrictive guided wave in a heat exchange pipe made of ferromagnetic materials; the magnetostrictive guided wave being induced by an alternating current pulse; the method comprising:
1) by means of a computer, capturing analysis signals u(0), u(1), u(2), . . . , u(N) from the detection voltage;
2) by means of a band-pass filter, filtering said analysis signals u(0), u(1), u(2), . . . , u(N) to obtain filtered signals x(0), x(1), x(2), . . . , x(N); and
3) by means of the computer, denoising said filtered signals x(0), x(1), x(2), . . . , x(N) to obtain said denoised signals y(0), y(1), y(2), . . . , y(N) by:
a) initializing i to zero and setting M=[L/4], R=[M/2], wherein L is a length of the alternating current pulse;
b) forming a matrix A of R*(M−R+1) by using said filtered signals x(i), x(i+1), . . . , x(i+M−1):
$$A = [ \begin{matrix}x ( i ) & x ( i + 1 ) & … & x ( i + M - R ) \\ x ( i + 1 ) & x ( i + 2 ) & … & x ( i + M - R + 1 ) \\ ⋮ & ⋮ & ⋱ & ⋮ \\ x ( i + R - 1 ) & x ( i + R ) & … & x ( i + M - 1 )\end{matrix} ] ;$$
c) performing a singular value decomposition on said matrix A to obtain a singular matrix B comprising a plurality of eigenvalues λ₁, λ₂, . . . , λ_{R}:
$$B = [ \begin{matrix}{λ}_{1} & 0 & … & 0 & … & 0 \\ 0 & {λ}_{2} & … & 0 & … & 0 \\ ⋮ & ⋮ & ⋱ & ⋮ & ⋮ & ⋮ \\ 0 & 0 & … & {λ}_{R} & … & 0\end{matrix} ] ;$$
d) determining a median of said plurality of eigenvalues and selecting eigenvalues that are smaller than said median from said plurality of eigenvalues;
e) setting said selected eigenvalues in d) in said singular matrix B to zero to obtain a matrix C;
f) performing an inverse transformation of the singular value decomposition on said matrix C to obtain a matrix D:
$$D = [ \begin{matrix}y ( i ) & y ( i + 1 ) & … & y ( i + M - R ) \\ y ( i + 1 ) & y ( i + 2 ) & … & y ( i + M - R + 1 ) \\ ⋮ & ⋮ & ⋱ & ⋮ \\ y ( i + R - 1 ) & y ( i + R ) & … & y ( i + M - 1 )\end{matrix} ] ;$$
g) determining said denoised signals y(i), y(i+1), . . . , y(i+M−1) according to said matrix D; and
h) setting i to (i+M) and returns to b) until i=N+1−M to obtain said denoised signals y(0), y(1), y(2), . . . , y(N).
